(19) United States
(12) Patent Application Publication
(10) Pub. No.: US 2016/0150375 A1
(43) Pub. Date: May 26, 2016

(54) Devices and Methods for Locating Missing Items with a Wireless Signaling Device

(71) Applicant: Facebook, Inc., Menlo Park, CA (US)

(72) Inventors: Karthik Yogeeswaran, San Francisco, CA (US); Viktor Vladimirovich Passichenko, San Francisco, CA (US); Damian Kowalewski, Sunnyvale, CA (US); Georgiy Yakovlev, Pacifica, CA (US)

(21) Appl. No.: 14/550,867

(22) Filed: Nov. 21, 2014

(51) Int. Cl. H04W 4/02; H04W 52/02; H04W 72/04; H04W 4/06

(52) U.S. Cl. CPC H04W 4/025; H04W 4/06; H04W 52/0258; H04W 72/0446

(57) ABSTRACT

A portable electronic device has a display, a device positioning module, and a wireless communication module. Using a first application, the device: determines whether predetermined locator timing criteria are satisfied; if the predetermined locator timing criteria are satisfied, searches for wireless signals transmitted from wireless signaling devices; if wireless signals, transmitted from the wireless signaling devices, are identified from the searching, determines whether the identified wireless signals satisfy predetermined locator wireless signal criteria. If the identified wireless signals satisfy the predetermined locator wireless signal criteria, the device identifies an identifier of a respective wireless signaling device of the wireless signaling devices; identifies a geographic location of the portable electronic device; and sends to a remote server system the identifier of the respective wireless signaling device and the geographic location of the portable electronic device.

### TECHNICAL FIELD

This relates generally to locating lost, stolen, or otherwise missing items, including but not limited to locating missing items using a wireless signaling device on the missing item.

### BACKGROUND

People often misplace their belongings or have them stolen. The missing items can be small or large (e.g., ranging from keys, wallets, purses, phones, tablets, laptops, briefcases, and backpacks to bicycles, cars, or other vehicles).

A number of lost-item trackers have been developed that use Bluetooth wireless tags attached to a given item, in conjunction with a dedicated tracking application on a smart phone, to help find the lost item.

But these lost-item trackers suffer from a number of drawbacks and limitations, including excessive power consumption, limited signaling range, and a small number of users with the dedicated tracking application operating on their phones.

### SUMMARY

Accordingly, there is a need for methods, devices, and computer readable storage media with more efficient ways to locate missing items with a wireless signaling device. Such methods and interfaces optionally complement or replace conventional methods for locate missing items with a wireless signaling device.

In accordance with some embodiments, a method is performed at a portable electronic device with a display, a device positioning module, a wireless communication module, one or more processors, and memory storing one or more programs, including a first application, for execution by the one or more processors. The method includes, with the first application: determining whether predetermined locator timing criteria are satisfied; and, in accordance with a determination that the predetermined locator timing criteria are satisfied, searching, while the predetermined locator timing criteria are satisfied, using the wireless communication module, for wireless signals transmitted from one or more wireless signaling devices. The one or more wireless signaling devices are located independent of the portable electronic device. The method also includes, in accordance with a determination that wireless signals, transmitted from the one or more wireless signaling devices, are identified from the searching, determining whether the identified wireless signals satisfy predetermined locator wireless signal criteria; and, in accordance with a determination that the identified wireless signals satisfy the predetermined locator wireless signal criteria: identifying an identifier of a respective wireless signaling device of the one or more wireless signaling devices, identifying a geographic location of the portable electronic device using the device positioning module, and sending to a server system that is located remotely from the portable electronic device the identifier of the respective wireless signaling device and the geographic location of the portable electronic device by executing instructions stored in the first application.

In accordance with some embodiments, a portable electronic device includes a display, a device positioning module, a wireless communication module, one or more processors, memory, and one or more programs including a first application. The one or more programs are stored in the memory and configured to be executed by the one or more processors and the one or more programs include instructions for performing, with the first application, the operations of the method described above. In accordance with some embodiments, a computer readable storage medium has stored therein instructions of one or more programs including a first application, which, when executed by a portable electronic device with a display, a device positioning module, a wireless communication module, and one or more processors, cause the portable electronic device to perform, with the first application, the operations of the method described above. In accordance with some embodiments, a portable electronic device includes: a display, a device positioning module, a wireless communication module, and means for performing the operations of the method described above.

Thus, portable electronic devices with displays, device positioning modules, and wireless communication modules are provided with more efficient methods for locating missing items with a wireless signaling device, thereby increasing the effectiveness, efficiency, and user satisfaction with such devices. Such methods may complement or replace conventional methods for locating missing items with a wireless signaling device.

In accordance with some embodiments, a method is performed at a wireless signaling device with a wireless communication module, a timing module, and one or more processors. The method includes: obtaining first timing information from the timing module; determining whether the first timing information satisfies predetermined timing criteria; and, in accordance with a determination that the predetermined timing criteria are satisfied: broadcasting wireless beacon signals using the wireless communication module while the predetermined timing criteria are satisfied. The broadcast wireless beacon signals include an identifier of the wireless signaling device. The method also includes searching, using the wireless communication module, for wireless response signals transmitted from a portable electronic device in response to receiving the wireless beacon signals. The wireless response signals include second timing information. The method further includes at least conditionally updating the timing module in accordance with the second timing information.

In accordance with some embodiments, a method is performed at a wireless signaling device with a wireless communication module, a timing module, and one or more processors. The method includes: obtaining timing information from the timing module; determining whether predetermined timing criteria are satisfied; and, in accordance with a determination that the predetermined timing criteria are satisfied, broadcasting wireless signals using the wireless communication module while the predetermined timing criteria are satisfied. The broadcast wireless signals include a beacon frame that contains an identifier of the wireless signaling device.

In accordance with some embodiments, a wireless signaling device includes a wireless communication module, a timing module, one or more processors, memory, and one or more programs; the one or more programs are stored in the memory and configured to be executed by the one or more processors and the one or more programs include instructions for performing the operations of any of the methods described above. In accordance with some embodiments, a wireless signaling device includes a wireless communication module, a timing module, and one or more processors configured for performing the operations of any of the methods described above. In accordance with some embodiments, a computer readable storage medium has stored therein instructions, which, when executed by a wireless signaling device with a wireless communication module, a timing module, and one or more processors, cause the wireless signaling device to perform the operations of any of the methods described above. In accordance with some embodiments, a wireless signaling device includes: a wireless communication module, a timing module, and means for performing the operations of any of the methods described above.

Thus, wireless signaling devices with wireless communication modules and timing modules are provided with more efficient methods for updating timing information, thereby increasing the effectiveness, efficiency, and user satisfaction with such devices. Such methods may complement or replace conventional methods for updating timing information.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an exemplary network architecture of a social network in accordance with some embodiments.

FIG. 1B is a diagram illustrating an exemplary network of client devices and wireless signaling devices in accordance with some embodiments.

FIG. 2 is a block diagram illustrating an exemplary social network system in accordance with some embodiments.

FIG. 3 is a block diagram illustrating an exemplary client device in accordance with some embodiments.

FIG. 4 is a block diagram illustrating an exemplary wireless signaling device in accordance with some embodiments.

FIGS. 5A-5B illustrate exemplary timing diagrams in accordance with some embodiments.

FIGS. 6A-6B illustrate exemplary data structures for wireless signals in accordance with some embodiments.

FIGS. 7A-7B illustrate exemplary user interfaces in accordance with some embodiments.

FIGS. 8A-8C are flow diagrams illustrating a method of locating a wireless signaling device in accordance with some embodiments.

FIGS. 9A-9B are flow diagrams illustrating a method of updating timing information in accordance with some embodiments.

### DESCRIPTION OF EMBODIMENTS

Conventional wireless signaling devices for tracking items transmit high power wireless signals so that the wireless signaling devices can be detected over a certain distance, which quickly drains the battery of the wireless signaling device. In addition, such wireless signaling devices constantly transmit wireless signals, thereby further aggravating the power consumption problem. Such wireless signaling devices need relatively frequent battery replacements. Once a wireless signaling device loses its power, it can no longer transmit wireless signals, and thus, cannot be tracked using wireless signals.

As described below, a method of locating a wireless signaling device (also called herein a beacon device) is performed using a network of client devices (e.g., mobile phones, tablet devices, etc.). The beacon devices may be coupled to, carried with, part of, or otherwise associated with any physical object, such as keys, wallets, purses, phones, tablets, laptops, briefcases, backpacks, children's clothing or shoes, bicycles, cars, or other vehicles, etc. The beacon devices broadcast wireless signals at set intervals or times of the day, for set durations. Client devices search for wireless signals from beacon devices at set intervals or times of the day, for set durations. When a client device identifies a wireless signal from a beacon device, the client device sends a response signal, and sends to a server system an identity of the beacon device and a location of the client device, with the client device location being a proxy for the location of the beacon device.

Because a large number of client devices are used to search for wireless signals, the beacon devices do not need to transmit high power wireless signals, thereby reducing power consumption. In addition, because the beacon device transmits wireless signals only at set intervals or times of the day, its power consumption is further reduced.

However, because the beacon device transmits wireless signals only at set intervals or times of the day (and the client devices search for wireless signals only at the same set intervals or times of the day), it is important that the beacon device maintains accurate timing information. If the beacon device has inaccurate timing information, the beacon device will transmit wireless signals at times other than when the client devices search for wireless signals, and the beacon device will not be located. The beacon device may use timing information sent from a client device to update its time.

The client-side operations for these methods may be performed by an application that is not a dedicated tracking application. For example, the client-side operations for these methods may be performed by a first application that is a social networking application (or other widely used application) running on a client device, which greatly increases the number of client devices that can ‘hear’ and locate the beacon device. Thus, in some embodiments, the first application is separate from an operating system of the client device. In some embodiments, the first application is included in the operating system of the client device.

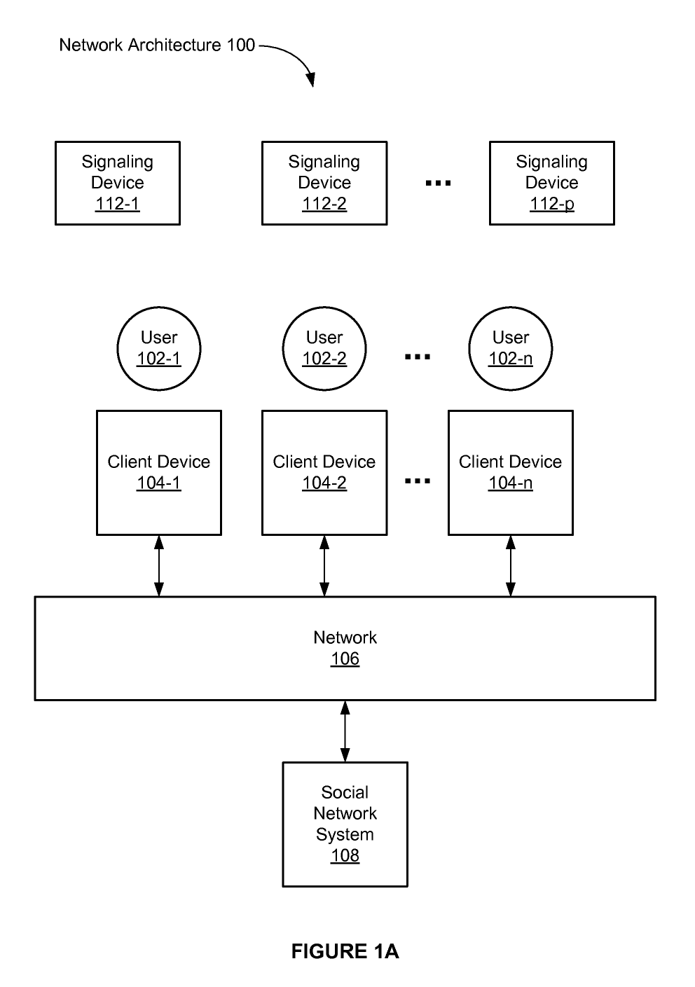

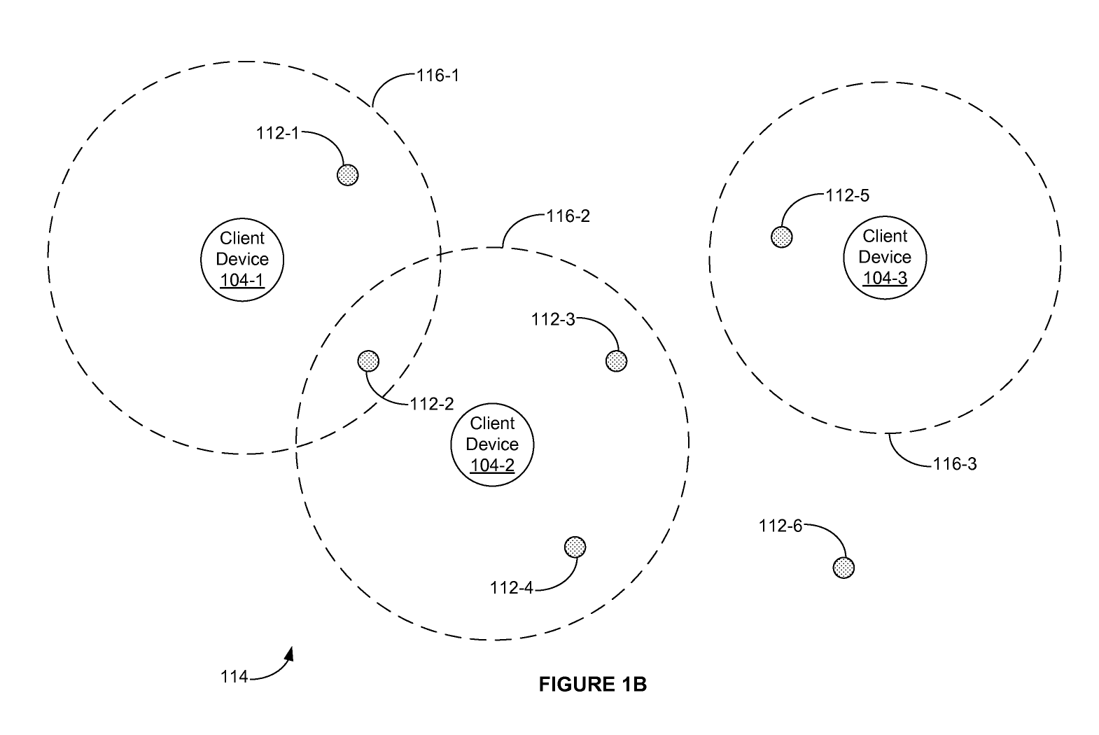

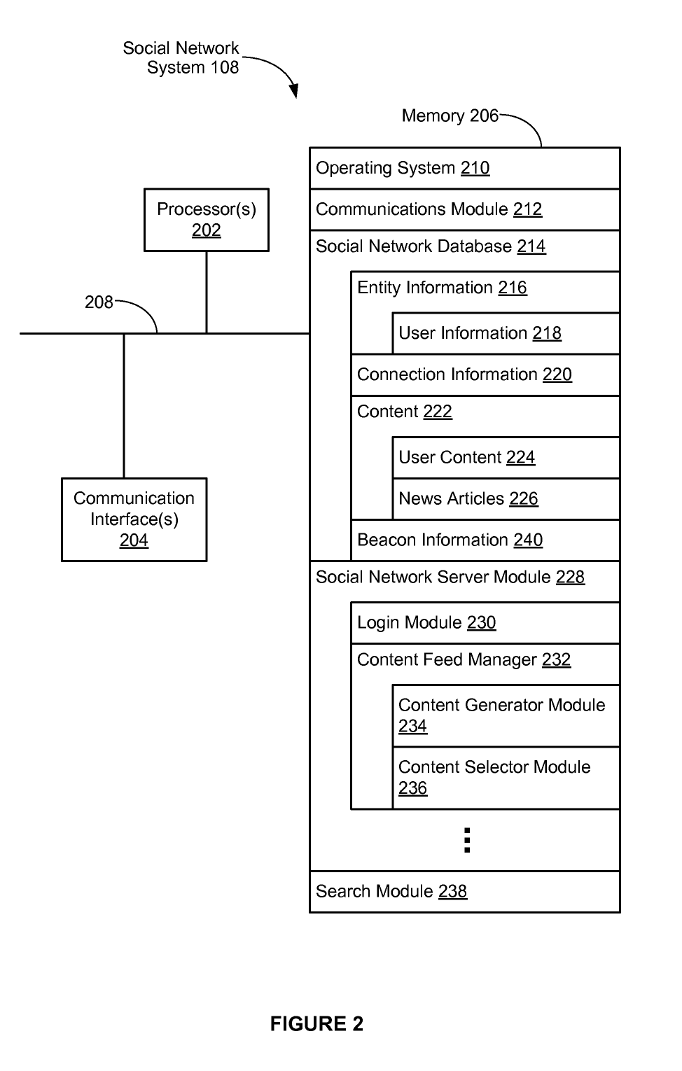

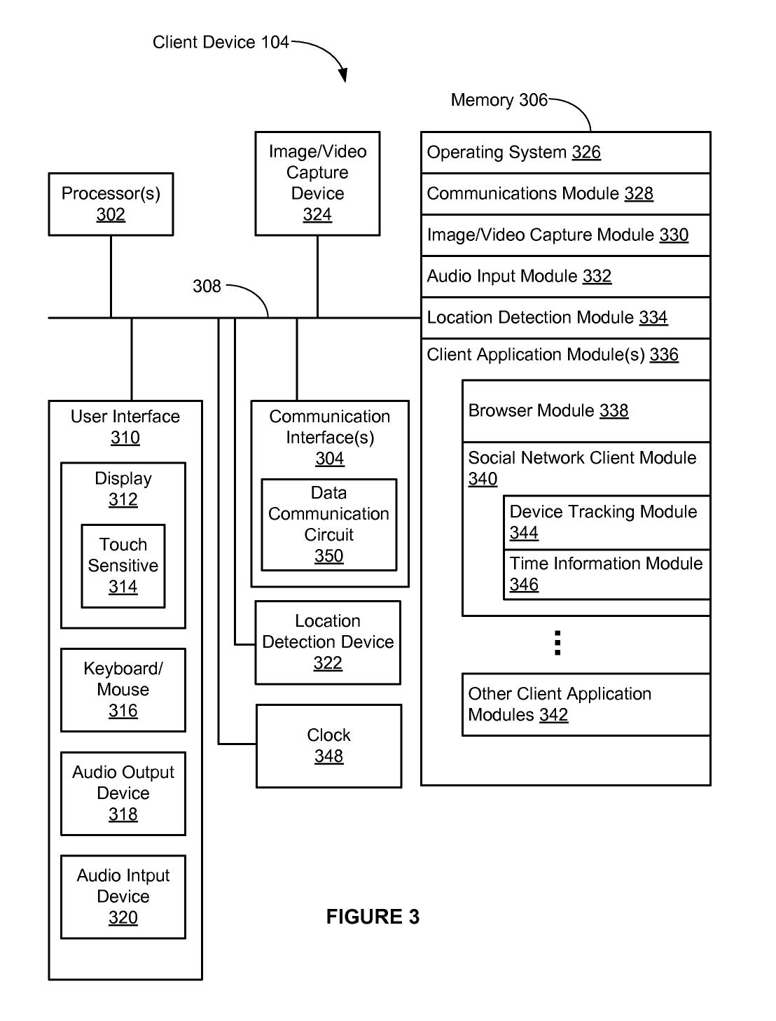

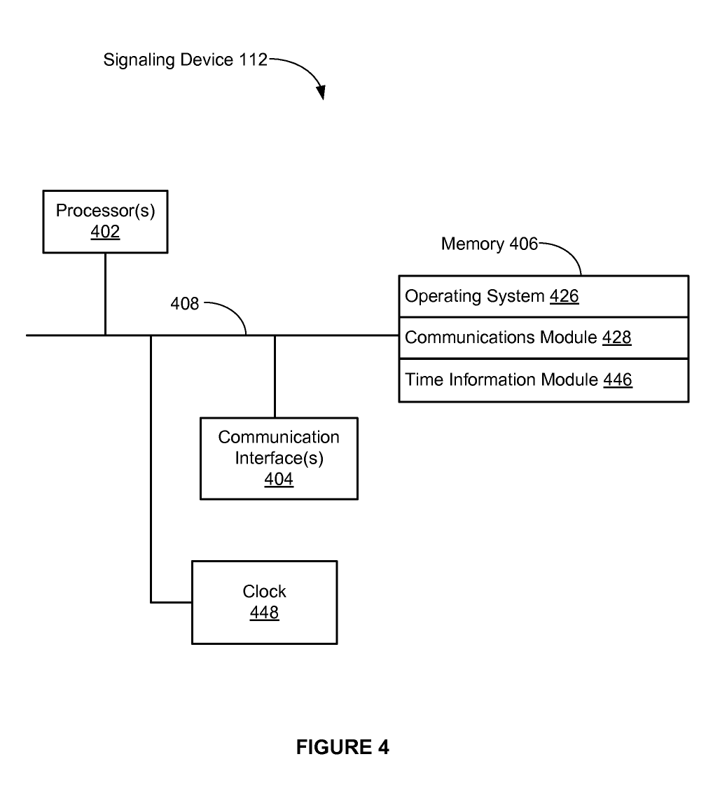

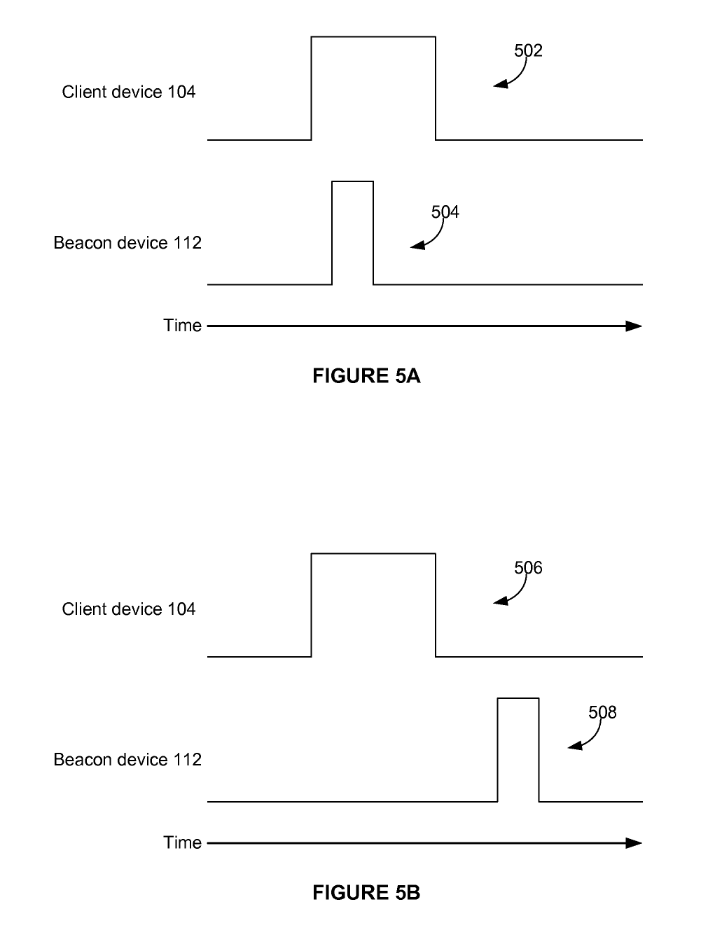

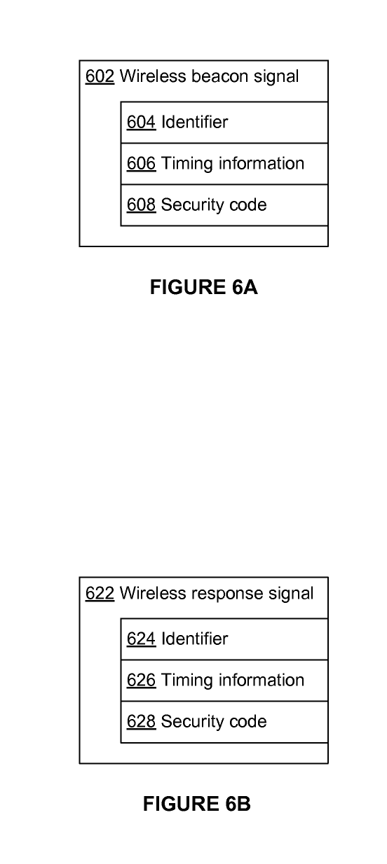

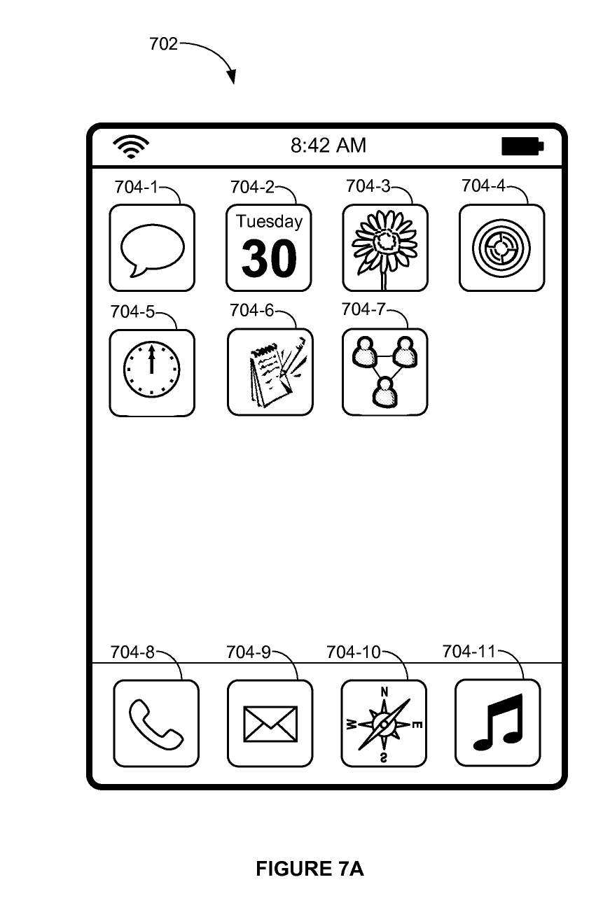

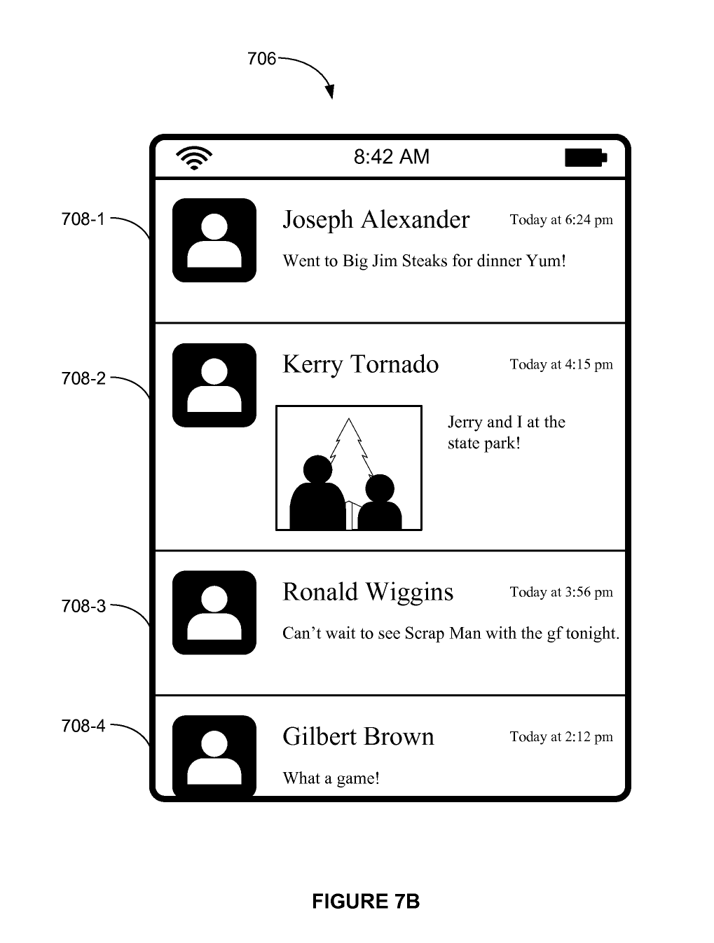

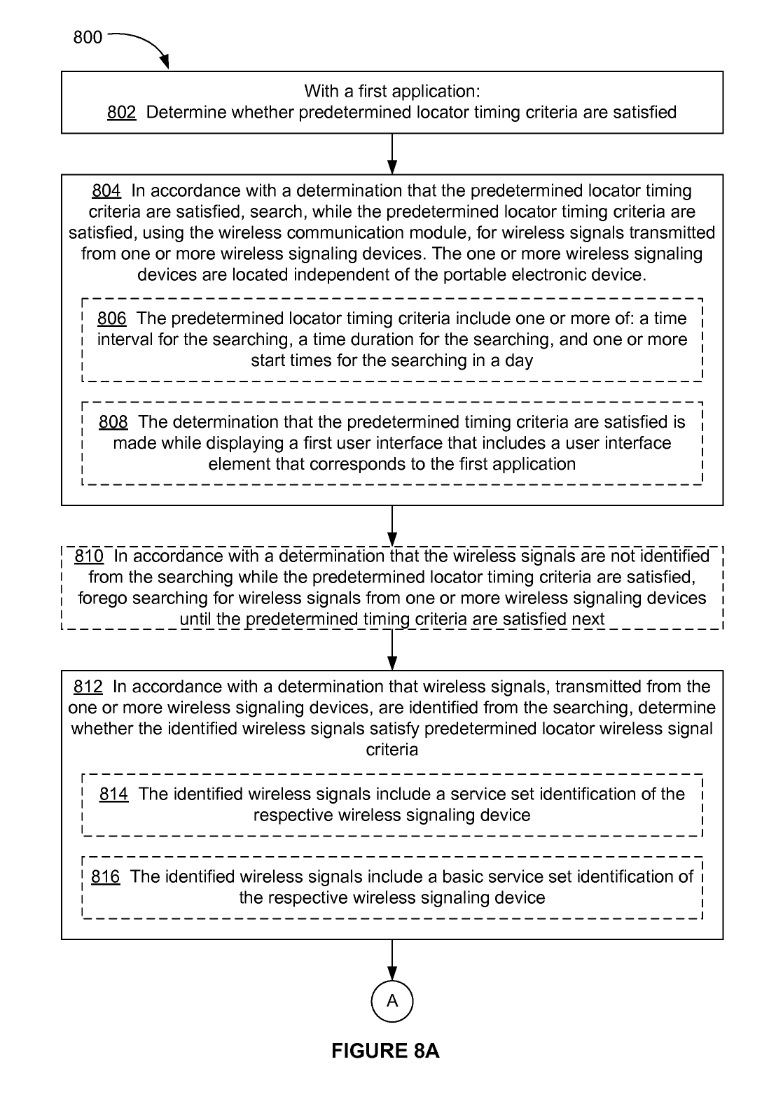

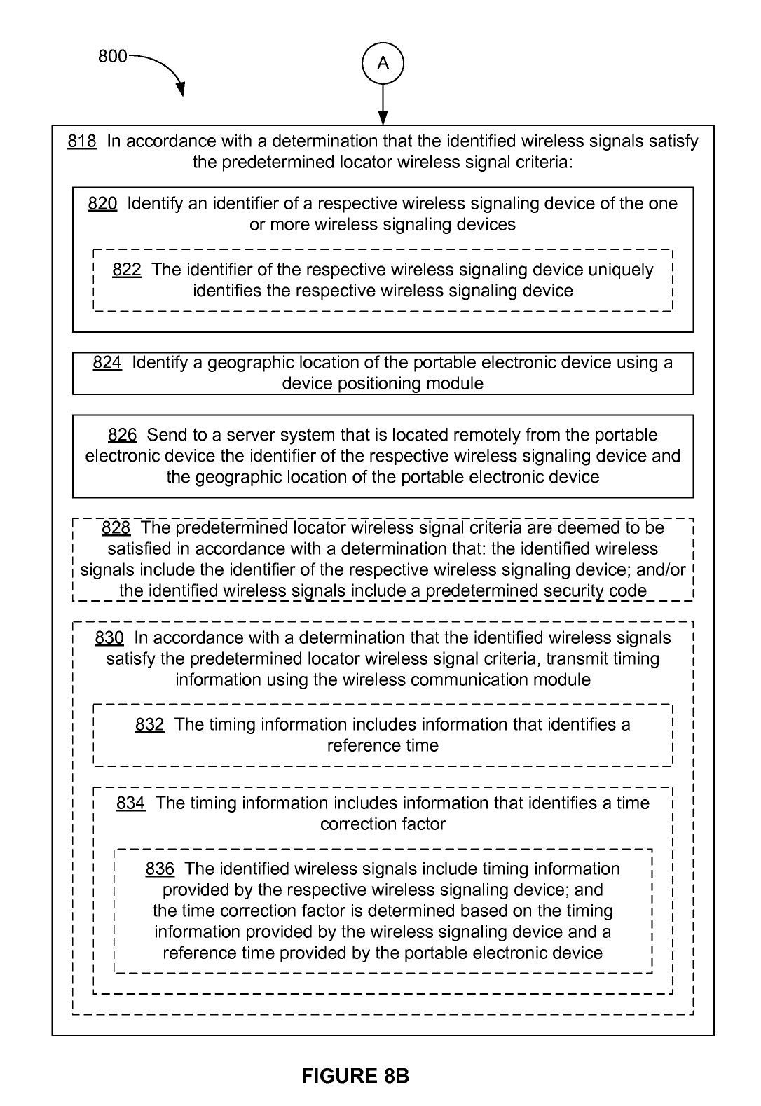

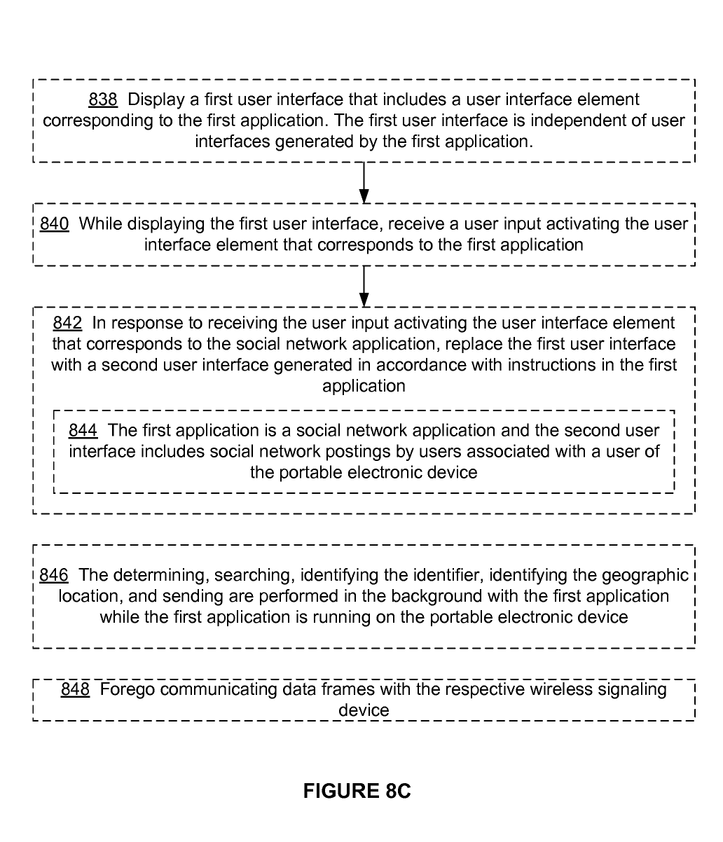

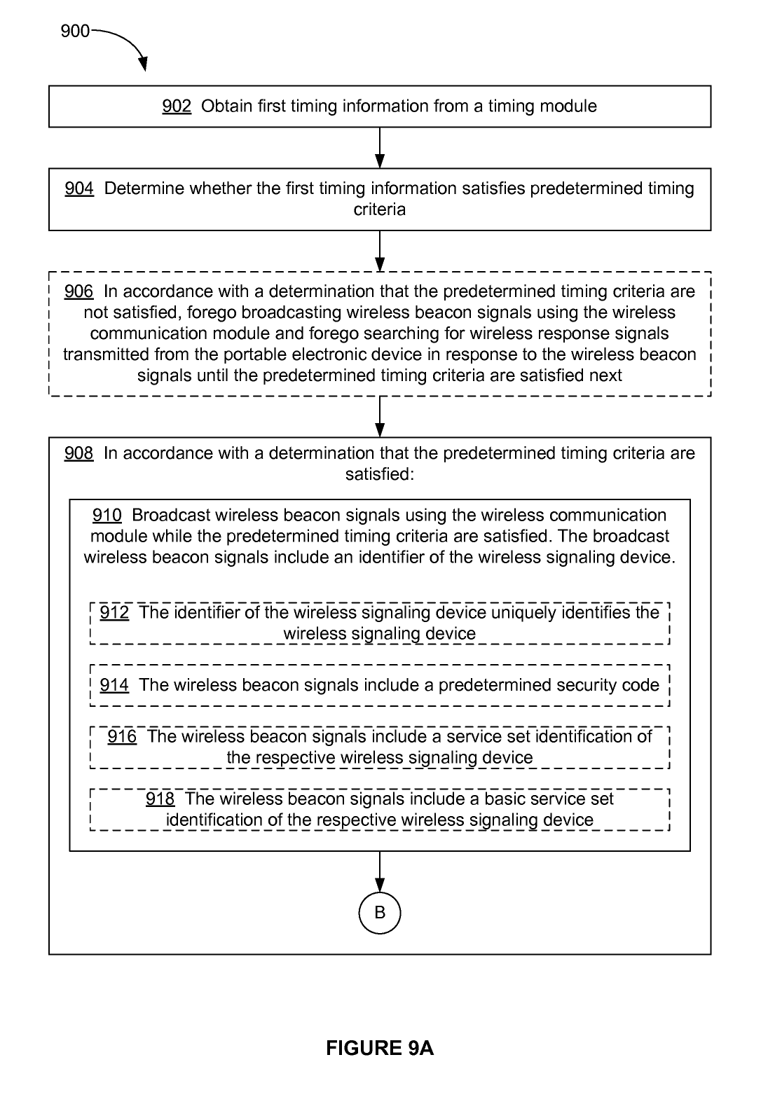

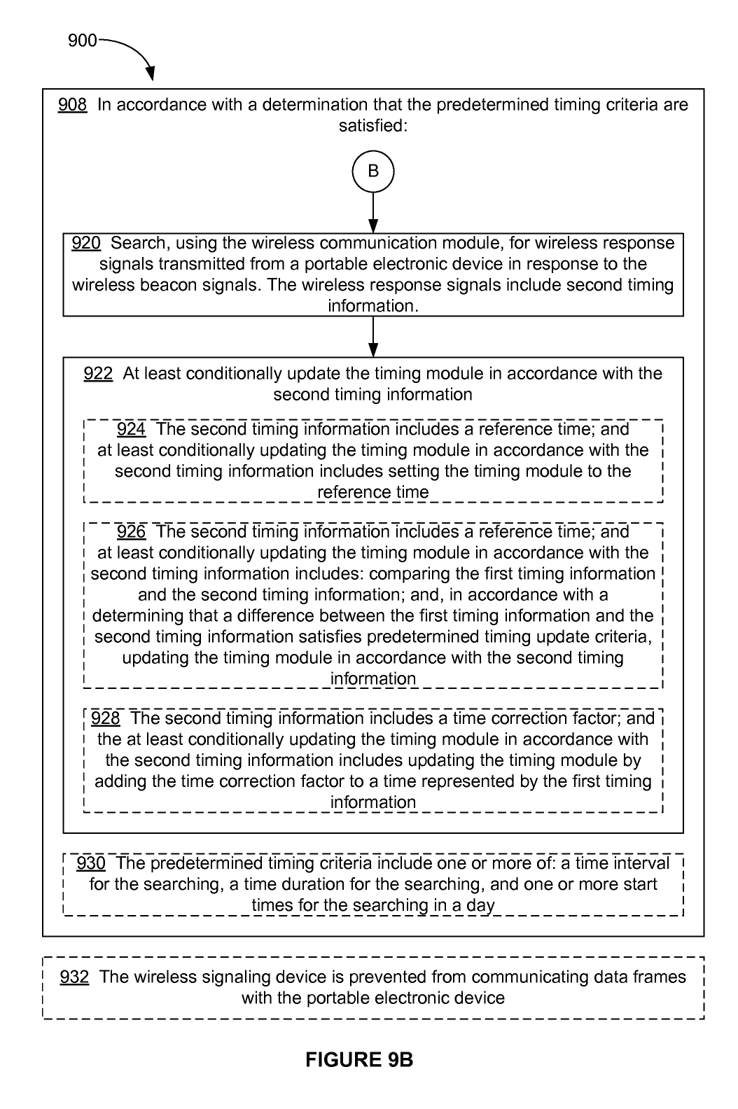

Below, FIGS. 1A-1B provide a description of an exemplary network architecture with client devices and wireless signaling devices. FIG. 2 provides a description of an exemplary server system. FIG. 3 provides a description of an exemplary client device. FIG. 4 provides a description of an exemplary wireless signaling device. FIGS. 5A-5B provide a description of the timing of wireless signals sent by client devices and wireless signaling devices. FIGS. 6A-6B provide a description of data structures of wireless signals sent by client devices and wireless signaling devices. FIGS. 7A-7B provide a description of user interfaces corresponding to a first application (e.g., a social networking application). FIGS. 8A-8C are flow diagrams illustrating a method of locating a wireless signaling device. FIGS. 9A-9B are flow diagrams illustrating a method of updating timing information at a wireless signaling device.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first user interface could be termed a second user interface, and, similarly, a second user interface could be termed a first user interface, without departing from the scope of the various described embodiments. The first user interface and the second user interface are both user interfaces, but they are not the same user interface.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

FIG. 1A is a block diagram illustrating an exemplary network architecture of a social network in accordance with some embodiments. The network architecture 100 includes a number of client devices (also called “client systems,” “client computers,” or “clients”) 104-1, 104-2, . . . 104-n communicably connected to a social network system 108 by one or more networks 106.

In some embodiments, the client devices 104-1, 104-2, . . . 104-n are computing devices, such as smart watches, personal digital assistants, portable media players, smart phones, tablet computers, 2D gaming devices, 3D (e.g., virtual reality) gaming devices, with one or more processors embedded therein or coupled thereto, in-vehicle information systems (e.g., an in-car computer system that provides navigation, entertainment, and/or other information), or other appropriate computing devices that can be used to communicate with an electronic social network system. In some embodiments, the social network system 108 is a single computing device, such as a computer server, while in other embodiments, the social network system 108 is implemented by multiple computing devices working together to perform the actions of a server system (e.g., cloud computing). In some embodiments, the network 106 is a public communication network (e.g., the Internet or a cellular data network), a private communications network (e.g., private LAN or leased lines), or a combination of such communication networks.

Users 102-1, 102-2, . . . 102-n employ the client devices 104-1, 104-2, . . . 104-n to access the social network system 108 and to participate in a social networking service. For example, one or more of the client devices 104-1, 104-2, . . . 104-n execute web browser applications that can be used to access the social networking service. As another example, one or more of the client devices 104-1, 104-2, . . . 104-n execute software applications that are specific to the social network (e.g., social networking “apps” running on smart phones or tablets, such as a Facebook social networking application running on an iPhone, Android, or Windows smart phone or tablet).

Users interacting with the client devices 104-1, 104-2, . . . 104-n can participate in the social networking service provided by the social network system 108 by posting information, such as text comments (e.g., updates, announcements, replies), digital photos, videos, audio files, links, and/or other electronic content. Users of the social networking service can also annotate information posted by other users of the social networking service (e.g., endorsing or “liking” a posting of another user, or commenting on a posting by another user). In some embodiments, information can be posted on a user's behalf by systems and/or services external to the social network or the social network system 108. For example, the user may post a review of a movie to a movie review website, and with proper permissions that website may cross-post the review to the social network on the user's behalf. In another example, a software application executing on a mobile client device, with proper permissions, may use global positioning system (GPS) or other geo-location capabilities (e.g., Wi-Fi or hybrid positioning systems) to determine the user's location and update the social network with the user's location (e.g., “At Home”, “At Work”, or “In San Francisco, Calif.”), and/or update the social network with information derived from and/or based on the user's location. Users interacting with the client devices 104-1, 104-2, . . . 104-n can also use the social network provided by the social network system 108 to define groups of users. Users interacting with the client devices 104-1, 104-2, . . . 104-n can also use the social network provided by the social network system 108 to communicate and collaborate with each other.

In some embodiments, the network architecture 100 also includes third-party servers (not shown). In some embodiments, a given third-party server is used to host third-party websites that provide web pages to client devices 104, either directly or in conjunction with the social network system 108. In some embodiments, the social network system 108 uses iframes to nest independent websites within a user's social network session. In some embodiments, a given third-party server is used to host third-party applications that are used by client devices 104, either directly or in conjunction with the social network system 108. In some embodiments, social network system 108 uses iframes to enable third-party developers to create applications that are hosted separately by a third-party server, but operate within a social networking session of a user and are accessed through the user's profile in the social network system. Exemplary third-party applications include applications for books, business, communication, contests, education, entertainment, fashion, finance, food and drink, games, health and fitness, lifestyle, local information, movies, television, music and audio, news, photos, video, productivity, reference material, security, shopping, sports, travel, utilities, and the like. In some embodiments, a given third-party server is used to host enterprise systems, that are used by client devices 104, either directly or in conjunction with the social network system 108. In some embodiments, a given third-party server is used to provide third-party content (e.g., news articles, reviews, message feeds, etc.).

In some embodiments, a given third-party server is a single computing device, while in other embodiments, a given third-party server is implemented by multiple computing devices working together to perform the actions of a server system (e.g., cloud computing).

In some embodiments, the network architecture 100 also includes wireless signaling devices 112-1, 112-2, . . . 112-p (which may also be called wireless transmitter devices, or wireless beacon devices; hereinafter referred to as “beacon device(s)” for convenience and ease of understanding). In some embodiments, a beacon device is attached to, carried with, held with, or otherwise physically coupled to another physical object (e.g., another electronic device, keys, wallet, etc.), held within a container (e.g., a box, a bag, a purse, etc.), and/or carried or worn by a person. A beacon device 112 may be physically coupled to another physical object by adhesive, Velcro, key ring, lanyard, or any other suitable way. A beacon device 112 may be concurrently physically coupled to an object (e.g., coupled to a keychain of keys) and held within a container (e.g., the keychain with the beacon device is held within a bag). A beacon device 112 maintains timing information (e.g., a clock time) within the beacon device. A beacon device 112 broadcasts wireless signals, which may be received by client devices 104, and receives wireless signals transmitted by client devices 104. In some embodiments, wireless signals broadcast or received by the beacon devices 112 do not include data frames; the beacon devices 113 are configured to forego sending and receiving data frames (e.g., data corresponding to documents, images, audio, etc.).

In some embodiments, a client device 104 receives wireless signals broadcast by the beacon device 112 and sends to the social network system 108 (or a separate server system) information in the received wireless signals (e.g., an identifier of the beacon device 112) and a geographic location of the client device 104 as a proxy of a geographic location of the beacon device 112. The social network system 108 (or the separate server system) receives the identifier of the beacon device 112 and the geographic location of the client device 104, and sends the geographic location of the client device 104 as a proxy of the geographic location of the beacon device 112 to a second client device 104 that is distinct from the client device 104 and associated with the beacon device 112 (e.g., a client device that is owned by an owner of the beacon device 112) so that the owner of the beacon device 112 can find an object coupled with the beacon device 112.

In some embodiments, each of multiple client devices 104 receives wireless signals broadcast by the beacon device 112 and sends to the social network system 108 (or a separate server system) information in the received wireless signals and a geographic location of the respective client device 104. The social network system 108 (or a separate server system) receives from the multiple client devices 104 geographic locations of the multiple client devices 104 and determines a geographic location of the beacon device 112 based on the geographic locations of the multiple client devices 104 (e.g., using triangulation).

Further details regarding the beacon devices and the wireless signals are described below.

FIG. 1B illustrates a network 114 of client devices and beacon devices in accordance with some embodiments. In some embodiments, the network 114 is a part of the network architecture 100 (FIG. 1A). The network 114 includes any number of client devices 104 and beacon devices 112. For brevity, only client devices 104-1 thru 104-3 and beacon devices 112-1 thru 112-6 are shown in FIG. 1B. Each client device 104 has a respective wireless communication range 116, in which wireless signals broadcast by beacon devices 112 may be identified, and wireless signals may be sent to beacon devices 112. In some embodiments, each beacon device 112 also has a respective wireless communication range; the wireless communication range of a beacon device 112 is smaller than the wireless communication range of a client device 104.

For example, client device 104-1 has a wireless communication range 116-1. Beacon device 112-1 is within the range 116-1. Thus, wireless signals broadcast by beacon device 112-1 may be identified by the client device 104-1, and wireless signals transmitted by the client device 104-1 may be received by the beacon device 112-1.

Beacon device 112-2 is also within the range 116-1 of client device 104-1 and range 116-2 of client device 104-2. Wireless signals broadcast by beacon device 112-2 may be identified by client devices 104-1 and 104-2, and wireless signals transmitted by client devices 104-1 and 104-2 may be received by the beacon device 112-2.

Beacon devices 112-2, 112-3 and 112-4 are within the range 116-2 of client device 104-2. Wireless signals broadcast by beacon devices 112-2, 112-3 and 112-4 may be identified by client device 104-2, and wireless signals transmitted by client device 104-2 may be received by beacon devices 112-2, 112-3 and 112-4.

Beacon device 112-5 is within the range 116-3 of client device 116-3. Thus, wireless signals broadcast by beacon device 112-5 may be identified by the client device 104-3, and wireless signals transmitted by the client device 104-3 may be received by the beacon device 112-5.

Beacon device 112-6 is not within any range 116 of a client device 104. Thus, wireless signals broadcast by beacon device 112-6 are not identified by any client device 104, and wireless signals transmitted by client devices 104 are not received by the beacon device 112-6.

It should be appreciated that the physical locations of client device 104 and beacon devices 112 may change (e.g., a user carrying a client device 104 moves around), and a beacon device 112 may move in or out of a range 116 of a client device 104.

In some embodiments, the client devices 104 search for wireless signals broadcast by beacon devices 112 at particular times, and the beacon devices 112 broadcast wireless signals at particular times. In some embodiments, the particular times when the searching or the broadcasting is performed are when one or more predetermined criteria are satisfied. For example, if a beacon device 112 broadcasts wireless signals at particular times and the client devices search for wireless signals at the same particular times, the client devices can detect the wireless signals broadcast by the beacon device 112 (if the beacon device 112 is located within a range of one or more client devices). If a beacon device 112 is broadcasting wireless signals, but the client devices 104, whose range the beacon device 112 is located in, are not searching for wireless signals, the wireless signals broadcast by the beacon device 112 are not identified by the client devices 104.

FIG. 2 is a block diagram illustrating an exemplary social network system 108 in accordance with some embodiments. The social network system 108 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The social network system 108 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 206 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the processor(s) 202. Memory 206, or alternately the non-volatile memory device(s) within memory 206, includes a non-transitory computer readable storage medium. In some embodiments, memory 206 or the computer readable storage medium of memory 206 stores the following programs, modules and data structures, or a subset or superset thereof:
an operating system 210 that includes procedures for handling various basic system services and for performing hardware dependent tasks;
a network communication module 212 that is used for connecting the social network system 108 to other computers via the one or more communication network interfaces 204 (wired or wireless) and one or more communication networks, such as the Internet, cellular telephone networks, mobile data networks, other wide area networks, local area networks, metropolitan area networks, and so on;
a social network database 214 for storing data associated with the social network, such as:
   entity information 216, such as user information 218;
   connection information 220; and
   content 222, such as user content 224 and/or news articles 226;
a social network server module 228 for providing social networking services and related features, in conjunction with browser module 338 or social network client module 340 on the client device 104, which includes:
   a login module 230 for logging a user 102 at a client 104 into the social network system 108; and
   a content feed manager 232 for providing content to be sent to clients 104 for display, which includes:
      a content generator module 234 for describing objects in the social network database 214, such as images, videos, audio files, comments, status messages, links, applications, and/or other entity information 216, connection information 220, or content 222; and
      a content selector module 236 for choosing the information/content to be sent to clients 104 for display; and
a search module 238 for enabling users of the social network system to search for content and other users in the social network.

The social network database 214 stores data associated with the social network in one or more types of databases, such as graph, dimensional, flat, hierarchical, network, object-oriented, relational, and/or XML databases.

In some embodiments, the social network database 214 includes a graph database, with entity information 216 represented as nodes in the graph database and connection information 220 represented as edges in the graph database. The graph database includes a plurality of nodes, as well as a plurality of edges that define connections between corresponding nodes. In some embodiments, the nodes and/or edges themselves are data objects that include the identifiers, attributes, and information for their corresponding entities, some of which are rendered at clients 104 on corresponding profile pages or other pages in the social networking service. In some embodiments, the nodes also include pointers or references to other objects, data structures, or resources for use in rendering content in conjunction with the rendering of the pages corresponding to the respective nodes at clients 104.

Entity information 216 includes user information 218, such as user profiles, login information, privacy and other preferences, biographical data, and the like. In some embodiments, for a given user, the user information 218 includes the user's name, profile picture, contact information, birth date, sex, marital status, family status, employment, education background, preferences, interests, and/or other demographic information.

In some embodiments, entity information 216 includes information about a physical location (e.g., a restaurant, theater, landmark, city, state, or country), real or intellectual property (e.g., a sculpture, painting, movie, game, song, idea/concept, photograph, or written work), a business, a group of people, and/or a group of businesses. In some embodiments, entity information 216 includes information about a resource, such as an audio file, a video file, a digital photo, a text file, a structured document (e.g., web page), or an application. In some embodiments, the resource is located in the social network system 108 (e.g., in content 222) or on an external server, such as third-party server 110.

In some embodiments, connection information 220 includes information about the relationships between entities in the social network database 214. In some embodiments, connection information 220 includes information about edges that connect pairs of nodes in a graph database. In some embodiments, an edge connecting a pair of nodes represents a relationship between the pair of nodes.

In some embodiments, an edge includes or represents one or more data objects or attributes that correspond to the relationship between a pair of nodes. For example, when a first user indicates that a second user is a “friend” of the first user, the social network system 108 transmits a “friend request” to the second user. If the second user confirms the “friend request,” the social network system 108 creates and stores an edge connecting the first user's user node and the second user's user node in a graph database as connection information 220 that indicates that the first user and the second user are friends. In some embodiments, connection information 220 represents a friendship, a family relationship, a business or employment relationship, a fan relationship, a follower relationship, a visitor relationship, a subscriber relationship, a superior/subordinate relationship, a reciprocal relationship, a non-reciprocal relationship, another suitable type of relationship, or two or more such relationships.

In some embodiments, an edge between a user node and another entity node represents connection information about a particular action or activity performed by a user of the user node towards the other entity node. For example, a user may “like,” “attended,” “played,” “listened,” “cooked,” “worked at,” or “watched” the entity at the other node. The page in the social networking service that corresponds to the entity at the other node may include, for example, a selectable “like,” “check in,” or “add to favorites” icon. After the user clicks one of these icons, the social network system 108 may create a “like” edge, “check in” edge, or a “favorites” edge in response to the corresponding user action. As another example, the user may listen to a particular song using a particular application (e.g., an online music application). In this case, the social network system 108 may create a “listened” edge and a “used” edge between the user node that corresponds to the user and the entity nodes that correspond to the song and the application, respectively, to indicate that the user listened to the song and used the application. In addition, the social network system 108 may create a “played” edge between the entity nodes that correspond to the song and the application to indicate that the particular song was played by the particular application.

In some embodiments, content 222 includes text (e.g., ASCII, SGML, HTML), images (e.g., jpeg, tif and gif), graphics (vector-based or bitmap), audio, video (e.g., mpeg), other multimedia, and/or combinations thereof. In some embodiments, content 222 includes executable code (e.g., games executable within a browser window or frame), podcasts, links, and the like.

In some embodiments, the social network server module 228 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

In some embodiments, the social network database 214 also includes beacon information 240. Beacon information 240 includes information on beacon devices 112 sent by client devices 104 that identified wireless signals from the beacon devices 112. In some embodiments, the beacon information 240 includes identifiers of the beacon devices 112 for which wireless signals were identified by the client devices 104, and locations (e.g., geographic locations) of the client devices 104 as proxies for the locations of the beacon devices 112.

FIG. 3 is a block diagram illustrating an exemplary client device 104 in accordance with some embodiments. The client device 104 typically includes one or more processing units (processors or cores) 302, one or more network or other communications interfaces 304, memory 306, and one or more communication buses 308 for interconnecting these components. The communication buses 308 optionally include circuitry (sometimes called a chipset) that interconnects and controls communications between system components. The client device 104 includes a user interface 310. The user interface 310 typically includes a display device 312. In some embodiments, the client device includes inputs such as a keyboard, mouse, and/or other input buttons 316. Alternatively or in addition, in some embodiments, the display device 312 includes a touch-sensitive surface 314, in which case the display device 312 is a touch-sensitive display. In client systems that have a touch-sensitive display 312, a physical keyboard is optional (e.g., a soft keyboard may be displayed when keyboard entry is needed). The user interface 310 also includes an audio output device 318, such as speakers or an audio output connection connected to speakers, earphones, or headphones. Furthermore, some client devices 104 use a microphone and voice recognition to supplement or replace the keyboard. The client device 104 includes a location detection device 322, such as a GPS (global positioning satellite) or other geo-location receiver, for determining the location of the client device 104. Optionally, the client device 104 includes an audio input device 320 (e.g., a microphone) to capture audio (e.g., speech from a user). The client device 104 also optionally includes an image/video capture device 324, such as a camera or webcam.

In some embodiments, the client device 104 also includes a clock or some other timing device 348. In some embodiments, the clock 348 includes a crystal oscillator that oscillates at a known frequency, based on which the client device 104 can measure time. In some embodiments, the clock 348 includes a radio clock that receives timing information transmitted by a radio transmitter (e.g., a transmitter located at a radio station). In some embodiments, the clock 348 utilizes information from the location detection device 322 (e.g., a GPS or other geo-location receiver) for calibration.

Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the processor(s) 302. Memory 306, or alternately the non-volatile memory device(s) within memory 306, includes a non-transitory computer readable storage medium. In some embodiments, memory 306 or the computer readable storage medium of memory 306 stores the following programs, modules and data structures, or a subset or superset thereof:
an operating system 326 that includes procedures for handling various basic system services and for performing hardware dependent tasks;
a network communication module 328 that is used for connecting the client device 104 to other computers and devices via the one or more communication network interfaces 304 (wired or wireless) and one or more communication networks, such as the Internet, cellular telephone networks, mobile data networks, other wide area networks, local area networks, metropolitan area networks, and so on;
an image/video capture module 330 (e.g., a camera module) for processing a respective image or video captured by the image/video capture device 324, where the respective image or video may be sent or streamed (e.g., by a client application module 336) to the social network system 108;
an audio input module 332 (e.g., a microphone module) for processing audio captured by the audio input device 320, where the respective audio may be sent or streamed (e.g., by a client application module 336) to the social network system 108;
a location detection module 334 (e.g., a GPS, Wi-Fi, or hybrid positioning module) for determining the location of the client device 104 (e.g., using the location detection device 322) and providing this location information for use in various applications (e.g., social network client module 340); and
one or more client application modules 336, including the following modules (or sets of instructions), or a subset or superset thereof:
   a web browser module 338 (e.g., Internet Explorer by Microsoft, Firefox by Mozilla, Safari by Apple, or Chrome by Google) for accessing, viewing, and interacting with web sites (e.g., a social networking web site such as www.facebook.com),
   a social network module 340 for providing an interface to a social network (e.g., a social network provided by social network system 108) and related features; and/or
   other optional client application modules 342, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

In some embodiments, the social network client module 340 includes a device tracking module 344 for searching for and identifying wireless signals broadcast by beacon devices 112, and a time information module 346 for determining timing information (e.g., a time correction factor) for transmission to beacon devices 112.

In some embodiments, the communications interfaces 304 include one or more data communications circuits 350 for communicating data frames (e.g., data corresponding to documents, audio, video, images, etc.).

FIG. 4 is a block diagram illustrating an exemplary wireless signaling device 112 (i.e., beacon device) in accordance with some embodiments. The wireless signaling device 112 typically includes one or more processing units (processors or cores) 402, one or more network or other communications interfaces 404, memory 406, and one or more communication buses 408 for interconnecting these components. The communication buses 408 optionally include circuitry (sometimes called a chipset) that interconnects and controls communications between system components. The wireless signaling device 112 also includes a clock or some other timing device 448. In some embodiments, the clock 448 includes a crystal oscillator that oscillates at a known frequency, based on which the wireless signaling device 112 can measure time. Although the processor 402, the one or more communication interfaces 404, the memory 406, and the clock 448 are illustrated as separate components, in some embodiments, the processor 402, the one or more communication interfaces 404, the memory 406, and the clock 448 are included in a single chip or circuit (e.g., application-specific integrated circuit).

Memory 406 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 406, or alternately the non-volatile memory device(s) within memory 406, includes a non-transitory computer readable storage medium. In some embodiments, memory 406 or the computer readable storage medium of memory 406 stores the following programs, modules and data structures, or a subset or superset thereof:
an operating system 426 that includes procedures for handling various basic system services and for performing hardware dependent tasks;
a network communication module 428 that is used for wirelessly connecting the wireless signaling device 112 to one or more client devices via the one or more communication network interfaces 404 (e.g., using the WiFi protocol or the carrier sense multiple access (CSMA) protocol); and
a time information module 446 for determining timing information for transmission to client devices 104 and/or updating the timing information.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 206, 306, and/or 406 store a subset of the modules and data structures identified above. Furthermore, memory 206, 306, and/or 406 optionally store additional modules and data structures not described above.

FIGS. 5A-5B illustrate exemplary timing diagrams in accordance with some embodiments. FIG. 5A illustrates a timeline with a square wave 502 representing when a client device 104 searches for wireless signals broadcast by beacon devices 112 (more particularly, highs of the square wave 502 represent periods when the client device 104 is searching), and a square wave 504 representing when a beacon device 112 is broadcasting wireless signals (more particularly, highs of the square wave 504 represent periods when the beacon device 112 is broadcasting). In FIG. 5A, the period when the client device 104 is searching and the period when the beacon device 112 is broadcasting coincide; the client device 104 can find and identify the wireless signals from the beacon device 112, assuming that the beacon device 112 is in range.

On the other hand, FIG. 5B illustrates a timeline with a square wave 506 representing when a client device 104 searches for wireless signals broadcast by beacon devices 112, and a square wave 508 representing when a beacon device 112 is broadcasting wireless signals. In FIG. 5B, the period when the client device 104 is searching and the period when the beacon device 112 is broadcasting do not coincide; the wireless signals broadcast by the beacon device 112 are not identified by the client device 104.

Although each of FIGS. 5A-5B illustrates a single period when the client device 104 is searching and a single period when the beacon device 112 is broadcasting, the client device 104 searches for wireless signals at multiple separate periods and the beacon device 112 transmits wireless signals at multiple separate periods. For example, the beacon device 112 may transmit multiple broadcasts in a single searching period by the client device 104.

FIGS. 6A-6B illustrate exemplary data structures for wireless signals in accordance with some embodiments. FIG. 6A illustrates a wireless beacon signal 602 broadcast by a beacon device 112 in accordance with some embodiments. In some embodiments, the beacon signal 602 includes an identifier 604 of the beacon device 112 (e.g., a service set identifier (SSID) of the beacon device 112 or a basic service set identification (BSSID) of the beacon device 112), optionally timing information 606 of the beacon device 112, and optionally a security code 608.

FIG. 6B illustrates a wireless response signal 622 transmitted by a client device 104 (e.g., in response to receiving an identified wireless beacon signal) in accordance with some embodiments. In some embodiments, the response signal 622 includes an identifier 624 of the beacon device 112 (for which the response signal is directed) (e.g., a SSID or BSSID of the beacon device 112), timing information 626 of the client device 104, and optionally a security code 628. In some embodiments, the timing information 626 includes a reference time or a time correction factor determined based on timing information 606 received from a beacon device 112 and a reference time. In some embodiments, the security code 628 is identical to the security code 608.

FIGS. 7A-7B illustrate exemplary user interfaces on a client device 104 in accordance with some embodiments. FIG. 7A illustrates a user interface 702 displayed on a portable electronic device (e.g., a smartphone or a tablet device). In some embodiments, the user interface 702 is a home screen for a smartphone.

The user interface 702 includes multiple user interface objects 704 (e.g., icons), each of which respectively corresponds to a respective application. For example, object 704-1 corresponds to a messaging application. Object 704-2 corresponds to a calendar application. Object 704-3 corresponds to a photos application. Object 704-4 corresponds to a camera application. Object 704-5 corresponds to a clock application. Object 704-6 corresponds to a notes application. Object 704-7 corresponds to a social networking application (e.g., social network client module 340). Object 704-8 corresponds to a telephony application. Object 704-9 corresponds to an email application. Object 704-10 corresponds to a web browser application. Object 704-11 corresponds to a music application.

As described above, the user interface object 704-7 corresponds to a social networking application. A user may activate the object 704-7 by performing a gesture (e.g., a tap gesture) on the object 704-7, double-click on the object 704-7 with a pointer, or the like. In response to activation of the object 704-7, a user interface of the corresponding social networking application, an example of which is illustrated in FIG. 7B, is displayed on the client device 104.

FIG. 7B illustrates a user interface 706 of the social networking application (e.g., social network client module 340). The user interface 706 is an interface showing multiple posts 708-1 thru 708-4 (e.g., a timeline of posts by a user's friends in a social network). The user may dismiss the interface 706 and return to the user interface 702 by activating a home button or key, minimizing a window, or the like.

In some embodiments, when the user interface 706 is dismissed and the user interface 702 is displayed, the social networking application continues to run in the background and performs certain operations.

In some embodiments, at the client device 104, the social networking application (e.g., social network client module 340) performs operations related to wireless signals from beacon devices 112, including searching for wireless signals from beacon devices 112, identifying these wireless signals, processing identified wireless signals, and generating wireless response signals for transmission. In some embodiments, the social networking application performs these operations while in the foreground (e.g., when the social networking application is running, and a user interface of the social networking application (e.g., user interface 706) is displayed) and in the background (e.g., when the social networking application is running, but a user interface other than a user interface of the social networking application is displayed, such as user interface 702 being displayed and user interface 706 being hidden).

Attention is now directed towards embodiments of processes that may be implemented on a client device (e.g., the client device 104 in FIG. 3) and a wireless signaling device (e.g., the beacon device 112 in FIG. 4), respectively.

FIGS. 8A-8C are flow diagrams illustrating a method 800 of locating a wireless signaling device with a client device (e.g., client device 104) in accordance with some embodiments. FIGS. 8A-8C correspond to instructions stored in a computer memory or computer readable storage medium (e.g., memory 306). In some embodiments, the method 800 is performed at a portable electronic device (e.g., a mobile phone, a tablet, etc.; client device 104) with a display (e.g., display 312), a device positioning module (e.g., location detection module 334 that works with location detection device 322), a wireless communication module (e.g., a Wi-Fi communication module operating pursuant to IEEE 802.11 specifications; communication module 328 that works with communications interface 304), and a first application stored in the memory. In some embodiments, the first application is not a dedicated tracking application. For example, the first application is a social network application (e.g., social network client module 340) or other widely-used application that is not a dedicated tracking application for finding/tracking a wireless signaling device. For example, the first application is optionally a phone application, an email application, a messaging application, a browsing application, a music player application, or other application (besides a dedicated tracking application) that is installed and running on a large number of portable electronic devices. In some embodiments, the method 800 is performed with the first application. In some embodiments, the first application is included in the operating system of the portable electronic device. In some embodiments, the first application is separate from the operating system of the portable electronic device.

As described below, a wireless signaling device broadcasts wireless signals at particular times (and not at other times) and the portable electronic device searches for wireless signals at particular times (and not at other times). Because the beacon device transmits wireless signals only at set intervals or times of the day, its power consumption is reduced, extending the battery life of the beacon device. Similarly, because the portable electronic device searches for wireless signals only at set intervals or times of the day, its power consumption is reduced, extending its battery life of the portable electronic device. Thus, portable electronic devices are provided with more efficient methods for locating missing items with a wireless signaling device, thereby increasing the effectiveness, efficiency, battery life, and user satisfaction with such devices.

The client determines (802) whether predetermined locator timing criteria are satisfied (e.g., searching for 10 seconds or 1 minute in every 15 minutes, every 30 minutes, every hour, etc.).

In accordance with a determination that the predetermined locator timing criteria are satisfied, the client searches (804), while the predetermined locator timing criteria are satisfied, using the wireless communication module, for wireless signals (e.g., Wi-Fi signals) transmitted from one or more wireless signaling devices. The one or more wireless signaling devices are located independent of the portable electronic device. For example, the one or more wireless signaling devices are located separately from the portable electronic device. In some embodiments, the wireless signals are included in a beacon frame broadcast from a respective wireless signaling device. The client device 104, for example, searches for wireless signals transmitted (e.g., broadcast) by one or more beacon devices 112 that are located independent of the client device 104. The client device 104 searches for the wireless signals while the predetermined locator timing criteria are satisfied (e.g., the client device is still in the time interval for searching).

In some embodiments, the predetermined timing criteria include one or more of (806): a time interval for the searching (e.g., every fifteen minutes or every hour), a time duration for the searching (e.g., searching for ten seconds, for one minute, etc.), and one or more start times for the searching in a day (e.g., at 7:00 AM, 10:00 AM, 12:00 PM, 2:00 PM, 5:00 PM). The predetermined locator timing criteria specifies time intervals between searches for wireless signals, time durations between searches, and/or specific times of the day for starting searches.

In some embodiments, the determination that the predetermined timing criteria are satisfied is made (808) while displaying a first user interface that includes a user interface element that corresponds to the first application. For example, the client device 104 makes the determination that the predetermined locator timing criteria are satisfied while user interface 702 (FIG. 7A), which includes icon 704-7 corresponding to a social networking application (the first application), is displayed; the social networking application is running and in the background.

In some embodiments, in accordance with a determination that the wireless signals are not identified from the searching while the predetermined locator timing criteria are satisfied, the client foregoes (810) searching for wireless signals from one or more wireless signaling devices until the predetermined timing criteria are satisfied next. For example, if the client device 104 does not identify any wireless signals from the search (e.g., because no beacon devices are in range during the search period of the client device 104, or because (as shown in the timing diagram illustrated in FIG. 5B) the wireless signal transmission period of the beacon device 112 does not coincide with the searching period of the client device 104), the client device 104 stops searching until the next instance of satisfaction of the predetermined locator timing criteria.

In accordance with a determination that wireless signals, transmitted from the one or more wireless signaling devices, are identified from the searching, the client determines (812) whether the identified wireless signals satisfy predetermined locator wireless signal criteria. For example, if the client device 104 identifies wireless signals from a beacon device 112 from the searching, the client device 104 determines if the identified signals satisfy predetermined locator wireless signal criteria.

In some embodiments, the identified wireless signals include a service set identification (SSID) of the respective wireless signaling device (814). For example, the wireless beacon signal 602 of the beacon device 112 includes an SSID of the beacon device 112.

In some embodiments, the identified wireless signals include a basic service set identification (BSSID) of the respective wireless signaling device (816). The wireless signal 602 (FIG. 6A) of the beacon device 112 includes a BSSID of the beacon device 112, for example. In some embodiments, the BSSID is persistently associated with the respective wireless signaling device (e.g., the BSSID is permanently associated with the respective wireless signaling device). In some embodiments, the BSSID is coded in a non-modifiable storage of the respective wireless signaling device (e.g., non-programmable read-only memory).

In accordance with a determination that the identified wireless signals satisfy the predetermined locator wireless signal criteria (818, FIG. 8B): the client identifies (820) an identifier of a respective wireless signaling device of the one or more wireless signaling devices, identifies (824) a geographic location of the portable electronic device using the device positioning module, and sends (826) to a server system that is located remotely from the portable electronic device the identifier of the respective wireless signaling device and the geographic location of the portable electronic device. For example, in accordance with a determination that the wireless signals from the beacon device 112 satisfy the predetermined locator wireless signal criteria, the client device 12 identifies an identifier of the beacon device 112 that transmitted the identified wireless signals, identifies a geographic location of the client device 104 using the location detection device 322, and sends to a server system (e.g., social network system 108) remote from the beacon devices 112 and client device 104 the identifier of the beacon device 112 and the geographic location of the client device 104. In some embodiments, the sending is performed by executing instructions in the first application. In some embodiments, the identifier of the beacon device 112 and the geographic location of the client device 104 are stored in the beacon information 240 at the social network system 108. In some embodiments, the geographic location of the client device 104 that identified the wireless signals of the beacon device 112 serves as a proxy for the geographic location of the beacon device 112.

In some embodiments, the identifier of the respective wireless signaling device uniquely identifies (822) the respective wireless signaling device (e.g., the identifier of the respective wireless signaling device is a unique identifier for the respective wireless signaling device). For example, the identifier 604 in the wireless beacon signal 602 uniquely identifies the beacon device 112 that transmitted the signal.

In some embodiments, the predetermined locator wireless signal criteria are deemed to be satisfied in accordance with a determination that: the identified wireless signals include the identifier of the respective wireless signaling device, and/or the identified wireless signals include a predetermined security code (828). For example, a wireless beacon signal 602 that includes an identifier 604 of the transmitting beacon device 112 and/or a predetermined security code 608 satisfies the predetermined locator wireless signal criteria. In some embodiments, the predetermined security code is included in the identifier of the respective wireless signaling device. For example, a portion of an SSID of the respective wireless signaling device includes the predetermined security code. In some embodiments, the predetermined security code is represented by predetermined alphanumeric characters.

In some embodiments, in accordance with a determination that the identified wireless signals satisfy the predetermined locator wireless signal criteria, the client transmits (830) timing information using the wireless communication module (e.g., to the respective wireless signaling device only or to all of the one or more wireless signaling devices). For example, if the wireless beacon signal(s) 602 satisfy the predetermined locator wireless signal criteria, the client device 104 transmits wireless response signals 622, which include timing information 626, determined by the time information module 346. In some embodiments, the timing information is included in an authentication frame, an association frame, or a probe request frame.

In some embodiments, the timing information includes (832) information that identifies a reference time (e.g., a current time determined by the portable electronic device). For example, the timing information 626 is the current time determined by the time information module 346 using the clock 348.

In some embodiments, the timing information includes (834) information that identifies a time correction factor (e.g., a difference between the reference time and a time provided by the respective wireless signaling device). For example, the timing information 626 is a time correction factor (e.g., plus or minus 3 seconds) determined by the time information module 346.

In some embodiments, the identified wireless signals include timing information provided by the respective wireless signaling device, and the time correction factor is determined based on the timing information provided by the wireless signaling device and a reference time provided by the portable electronic device (836). For example, the timing information 626 is a timing correction factor that is determined, by the time information module 346, based on a reference time at the client device 104 and timing information 606 included in the wireless beacon signal 602 (e.g., by subtracting a time that corresponds to the timing information 606 from the reference time).

In some embodiments, the client displays (838, FIG. 8C) a first user interface that includes a user interface element corresponding to the first application, where the first user interface is independent of user interfaces generated by the first application; while displaying the first user interface, receives (840) a user input activating the user interface element that corresponds to the first application; and, in response to receiving the user input activating the user interface element that corresponds to the social network application, replaces (842) the first user interface with a second user interface generated in accordance with instructions in the first application. For example, the client device 104 displays a user interface 702 (FIG. 7A), which includes a user interface object 704-7 corresponding to a social networking application. The client device 104 receives user input activating the user interface object 704-7 (e.g., receives a tap gesture on the user interface object 704-7). In response to receiving the activation input, the client device 104 replaces the user interface 702 with the user interface 706 (FIG. 7B) of the social networking application.

In some embodiments, the first application is a social network application and the second user interface includes social network postings by users associated with a user of the portable electronic device (844). For example, the user interface object 704-7 corresponds to a social networking application (e.g., social network client module 340). User interface 706 corresponding to the social networking application includes posts 708 associated made by friends of a user of the client device 104.

In some embodiments, the determining, searching, identifying the identifier, identifying the geographic location, and sending are performed in the background with the first application while the first application is running on the portable electronic device (846). For example, the determining, searching, identifying the identifier, identifying the geographic location, and sending are performed by the social network client module 340 (including device tracking module 344 and time information module 346) while the social network application is running but in the background (e.g., user interface 702 instead of user interface 706 is displayed).

In some embodiments, the client foregoes (848) communicating data frames with the respective wireless signaling device. In some embodiments, the portable electronic device is prevented from communicating data frames with the respective wireless signaling device. In some embodiments, the portable electronic device is not capable of communicating data frames with the respective wireless signaling device. For example, the communication interface(s) 304 of the client device 104 includes data communication circuit(s) 350, but the communication interface(s) 404 of the beacon device 112 does not. In some embodiments, the portable electronic device is capable of communicating data frames with the respective wireless signaling device (e.g., the portable electronic device includes circuitry for communicating data frames with wireless communication devices), but foregoes communicating data frames with the respective wireless signaling device.

FIGS. 9A-9B are flow diagrams illustrating a method 900 of updating timing information at a wireless signaling device (e.g., beacon device 112) in accordance with some embodiments. FIGS. 9A-9B correspond to instructions stored in a computer memory or computer readable storage medium (e.g., memory 406), or instructions hardwired into one or more processors (e.g., processor(s) 402). In some embodiments, the method 900 is performed at a wireless signaling device (e.g., a wireless beacon; beacon device 112) with a wireless communication module (e.g., a Wi-Fi communication module operating pursuant to IEEE 802.11 specifications; communications module 428 that works with communication interface(s) 404) and a timing module (e.g., time information module 446, clock 448). In some embodiments, the wireless signaling device is battery powered.

As described below, the beacon device transmits wireless signals only at set intervals or times of the day (and the client devices search for wireless signals only at the same set intervals or times of the day). Thus, it is important that the beacon device maintains accurate timing information. If the beacon device has inaccurate timing information, the beacon device will transmit wireless signals at times other than when the client devices search for wireless signals, and the beacon device will not be located. The beacon device uses timing information sent from a client device to update its time. This allows the beacon device to transmit wireless signals only at set intervals or times of the day, thereby reducing its power consumption and extending its battery life.

The wireless signaling device obtains (902) first timing information from the timing module. For example, the time information module 446 obtains or determines timing information based on the clock 448.

The wireless signaling device determines (904) whether the first timing information satisfies predetermined timing criteria. For example, the beacon device 112 determines whether the timing information obtained or determined by the time information module 446 satisfies predetermined timing criteria.

In some embodiments, in accordance with a determination that the predetermined timing criteria are not satisfied, the wireless signaling device foregoes (906) broadcasting wireless beacon signals using the wireless communication module and foregoes searching for wireless response signals transmitted from the portable electronic device in response to the wireless beacon signals until the predetermined timing criteria are satisfied next. If the timing criteria are not satisfied, the beacon device 112 stops broadcasting the wireless beacon signals and stops searching for response signals from client devices 104 until the next time the timing criteria are satisfied. In some embodiments, in accordance with a determination that the predetermined timing criteria are not satisfied, the wireless signaling device enters a power savings mode until the predetermined timing criteria are satisfied.

In accordance with a determination that the predetermined timing criteria are satisfied (908): the wireless signaling device broadcasts (910) wireless beacon signals using the wireless communication module while the predetermined timing criteria are satisfied, where the broadcast wireless beacon signals include an identifier of the wireless signaling device; searches (920, FIG. 9B), using the wireless communication module, for wireless response signals transmitted from a portable electronic device in response to the wireless beacon signals, where the wireless response signals include second timing information; and at least conditionally updates (922) the timing module in accordance with the second timing information. For example, in accordance with a determination that the predetermined timing criteria are satisfied, the beacon device 112 broadcasts wireless signals (e.g., wireless beacon signal 602) using the communications module 428 working with communication interface(s) 404 while the timing criteria are satisfied. The wireless signals include an identifier (e.g., identifier 604) of the beacon device 112. The beacon device 112 searches for wireless response signals (e.g., response signal 622) transmitted from a client device 104 in response to the wireless beacon signals. The wireless response signals include timing information (e.g., timing information 626). The beacon device 112 at least conditionally updates the clock 448 in accordance with the timing information from the wireless response signals. In some embodiments, the wireless beacon signals are included in a beacon frame broadcast from a respective wireless signaling device.

As used herein, at least conditionally updating the timing module includes one or more of: unconditionally updating the timing module and conditionally updating the timing module. In some embodiments, the wireless signaling device updates the timing module in response to receiving the second timing information unconditionally (without additional conditions, beyond receiving the second timing information, needing to be met to update the timing module). In some embodiments, the wireless signaling device updates the timing module in response to receiving the second timing information conditionally (with additional conditions, beyond receiving the second timing information from the portable electronic device, needing to be met to update the timing module).

In some embodiments, the identifier of the wireless signaling device uniquely identifies the wireless signaling device (912, FIG. 9A). For example, the identifier 604 in the wireless beacon signal 602 uniquely identifies the beacon device 112 that transmitted the signal.

In some embodiments, the wireless beacon signals include a predetermined security code (914). For example, a wireless beacon signal 602 includes a predetermined security code 608.

In some embodiments, the wireless beacon signals include a service set identification of the respective wireless signaling device (916). For example, the wireless beacon signal 602 of the beacon device 112 includes an SSID of the beacon device 112.

In some embodiments, the wireless beacon signals include a basic service set identification of the respective wireless signaling device (918). For example, the wireless signal 602 of the beacon device 112 includes a BSSID of the beacon device 112.

In some embodiments, the second timing information includes a reference time, and at least conditionally updating the timing module in accordance with the second timing information includes setting the timing module to the reference time (924, FIG. 9B). For example, the timing information 626 in the wireless response signal 622 is the current time determined by the time information module 346 using the clock 348. Updating the timing module at the beacon device 112 includes setting the clock 448 to the reference time specified in the timing information 626.

In some embodiments, the second timing information includes a reference time; and at least conditionally updating the timing module in accordance with the second timing information includes: comparing the first timing information and the second timing information, and, in accordance with a determining that a difference between the first timing information and the second timing information satisfies predetermined timing update criteria, updating the timing module in accordance with the second timing information (926). For example, the timing module is updated if the difference is more than 5 seconds. For example, the timing information 626 in the wireless response signal 622 is the current time determined by the time information module 346 using the clock 348. Updating the timing module at the beacon device 112 includes setting the clock 448 to the time specified in the timing information 626 if the difference between the time in the clock 448 and the reference time in the timing information 626 exceeds a threshold.

In some embodiments, the second timing information includes a time correction factor, and the at least conditionally updating the timing module in accordance with the second timing information includes updating the timing module by adding the time correction factor to a time represented by the first timing information (928). In some embodiments, the time correction factor is a positive number (e.g., 3 seconds). In some embodiments, the time correction factor is a negative number (e.g., −3 seconds). For example, the timing information 626 is a timing correction factor (e.g., plus or minus 3 seconds) determined by the time information module 346. Updating the timing module at the beacon device 112 includes adding the time correction factor to the time in the clock 448. In some embodiments, the second timing information includes a time correction factor, and the at least conditionally updating the timing module in accordance with the second timing information includes updating the timing module by subtracting the time correction factor to a time represented by the first timing information.

In some embodiments, the predetermined timing criteria include one or more of: a time interval for the searching, a time duration for the searching, and one or more start times for the searching in a day (930). The predetermined timing criteria specify time intervals between searches for wireless response signals, time durations between searches, and/or specific times of the day for starting searches.

In some embodiments, the wireless signaling device is prevented from communicating data frames with the portable electronic device (932). In some embodiments, the wireless signaling device forgoes communicating data frames with the portable electronic device. In some embodiments, the wireless signaling device does not have a circuit (e.g., the wireless signaling device does not have circuit like data communication circuit 350, FIG. 3) for communicating (e.g., sending and/or receiving) data frames with the portable electronic device, and the wireless signaling device is not capable of sending or receiving data frames. This reduces the size of the wireless signaling device, as the wireless signaling device does not need to include the circuit for communicating data frames with the portable electronic device. In addition, this reduces power consumption by the wireless signaling device, thereby increasing a battery life of the wireless signaling device. For example, the communication interface(s) of the client device 104 includes data communication circuit(s) 350, but the communication interface(s) of the beacon device 112 do not.

For situations in which the systems discussed above collect information about users, the users may be provided with an opportunity to opt in/out of programs or features that may collect personal information (e.g., information about a user's preferences or a user's contributions to social content providers). In addition, in some embodiments, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A computer readable storage medium, storing:
one or more programs, including a first application, for execution by one or more processors of an electronic device with a display, a device positioning module, and a wireless communication module, the one or more programs including instructions for:
with the first application:
determining whether predetermined locator timing criteria are satisfied;
in accordance with a determination that the predetermined locator timing criteria are satisfied, searching, while the predetermined locator timing criteria are satisfied, using the wireless communication module, for wireless signals transmitted from one or more wireless signaling devices, wherein the one or more wireless signaling devices are located independent of the portable electronic device;
in accordance with a determination that wireless signals, transmitted from the one or more wireless signaling devices, are identified from the searching, determining whether the identified wireless signals satisfy predetermined locator wireless signal criteria; and,
in accordance with a determination that the identified wireless signals satisfy the predetermined locator wireless signal criteria:
identifying an identifier of a respective wireless signaling device of the one or more wireless signaling devices;
identifying a geographic location of the portable electronic device using the device positioning module; and
sending to a server system that is located remotely from the portable electronic device the identifier of the respective wireless signaling device and the geographic location of the portable electronic device.

2. The computer readable storage medium of claim 1, wherein the one or more programs include instructions for:
displaying a first user interface that includes a user interface element corresponding to the first application, wherein the first user interface is independent of user interfaces generated by the first application;
while displaying the first user interface, receiving a user input activating the user interface element that corresponds to the first application; and,
in response to receiving the user input activating the user interface element that corresponds to the social network application, replacing the first user interface with a second user interface generated in accordance with instructions in the first application.

3. The computer readable storage medium of claim 2, wherein the first application is a social network application and the second user interface includes social network postings by users associated with a user of the portable electronic device.

4. The computer readable storage medium of claim 1, wherein the determining, searching, identifying the identifier, identifying the geographic location, and sending are performed in the background with the first application while the first application is running on the portable electronic device.

5. The computer readable storage medium of claim 1, wherein the identifier of the respective wireless signaling device uniquely identifies the respective wireless signaling device.

6. The computer readable storage medium of claim 1, wherein the one or more programs include instructions for:
in accordance with a determination that the wireless signals are not identified from the searching while the predetermined locator timing criteria are satisfied, foregoing searching for wireless signals from one or more wireless signaling devices until the predetermined timing criteria are satisfied next.

7. The computer readable storage medium of claim 1, wherein the predetermined timing criteria include one or more of: a time interval for the searching, a time duration for the searching, and one or more start times for the searching in a day.

8. The computer readable storage medium of claim 1, wherein the predetermined locator wireless signal criteria are deemed to be satisfied in accordance with a determination that:
the identified wireless signals include the identifier of the respective wireless signaling device; and/or
the identified wireless signals include a predetermined security code.

9. The computer readable storage medium of claim 1, wherein the determination that the predetermined timing criteria are satisfied is made while displaying a first user interface that includes a user interface element that corresponds to the first application.

10. The computer readable storage medium of claim 1, wherein the one or more programs include instructions for:
in accordance with a determination that the identified wireless signals satisfy the predetermined locator wireless signal criteria, transmitting timing information using the wireless communication module.

11. The computer readable storage medium of claim 10, wherein the timing information includes information that identifies a reference time.

12. The computer readable storage medium of claim 10, wherein the timing information includes information that identifies a time correction factor.

13. The computer readable storage medium of claim 12, wherein:
the identified wireless signals include timing information provided by the respective wireless signaling device; and
the time correction factor is determined based on the timing information provided by the wireless signaling device and a reference time provided by the portable electronic device.

14. The computer readable storage medium of claim 1, wherein the identified wireless signals include a service set identification of the respective wireless signaling device.

15. The computer readable storage medium of claim 1, wherein the identified wireless signals include a basic service set identification of the respective wireless signaling device.

16. The computer readable storage medium of claim 1, wherein the one or more programs include instructions for foregoing communicating data frames with the respective wireless signaling device.

17. A portable electronic device, comprising:
a display,
a device positioning module,
a wireless communication module,
one or more processors, and
memory storing one or more programs, including a first application, for execution by the one or more processors, the one or more programs including instructions for:
with the first application:
determining whether predetermined locator timing criteria are satisfied;
in accordance with a determination that the predetermined locator timing criteria are satisfied, searching, while the predetermined locator timing criteria are satisfied, using the wireless communication module, for wireless signals transmitted from one or more wireless signaling devices, wherein the one or more wireless signaling devices are located independent of the portable electronic device;
in accordance with a determination that wireless signals, transmitted from the one or more wireless signaling devices, are identified from the searching, determining whether the identified wireless signals satisfy predetermined locator wireless signal criteria; and,
in accordance with a determination that the identified wireless signals satisfy the predetermined locator wireless signal criteria:
identifying an identifier of a respective wireless signaling device of the one or more wireless signaling devices;
identifying a geographic location of the portable electronic device using the device positioning module; and
sending to a server system that is located remotely from the portable electronic device the identifier of the respective wireless signaling device and the geographic location of the portable electronic device.

18. A method, comprising:
at a portable electronic device having
a display,
a device positioning module,
a wireless communication module,
one or more processors, and
memory storing one or more programs, including a first application, for execution by the one or more processors:
with the first application:
determining whether predetermined locator timing criteria are satisfied;
in accordance with a determination that the predetermined locator timing criteria are satisfied, searching, while the predetermined locator timing criteria are satisfied, using the wireless communication module, for wireless signals transmitted from one or more wireless signaling devices, wherein the one or more wireless signaling devices are located independent of the portable electronic device;
in accordance with a determination that wireless signals, transmitted from the one or more wireless signaling devices, are identified from the searching, determining whether the identified wireless signals satisfy predetermined locator wireless signal criteria; and,
in accordance with a determination that the identified wireless signals satisfy the predetermined locator wireless signal criteria:
identifying an identifier of a respective wireless signaling device of the one or more wireless signaling devices;
identifying a geographic location of the portable electronic device using the device positioning module; and
sending to a server system that is located remotely from the portable electronic device the identifier of the respective wireless signaling device and the geographic location of the portable electronic device.
